(19) United States
(12) Patent Application Publication
(10) Pub. No.: US 2007/0027969 A1
(43) Pub. Date: Feb. 1, 2007

(54) Sensor device, server node, sensor network system, and method of controlling sensor device

(75) Inventor: Akihito Ishida, Yamatotakada-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/492,853

(22) Filed: Jul. 26, 2006

(30) Foreign Application Priority Data
Jul. 27, 2005 (JP) 2005-217841

(51) Int. Cl. G06F 15/177; G06F 17/30

(52) U.S. Cl. 709/222; 707/10

(57) ABSTRACT

A sensor network system includes (i) a server node that transmits and receives, via network, a signal to/from an external device having one or plural external application and (ii) one or plural sensor device connected to the server node. The server node includes a processor for reducing transmission from the sensor device in accordance with a detected-data request cycle by the external application. This reduces the power consumption by the sensor device.

This Nonprovisional application claims priority under U.S.C. § 119(a) on Patent Application No. 217841/2005 filed in Japan on Jul. 27, 2005, the entire contents of which are hereby incorporated by reference.

### FIELD OF THE INVENTION

The present invention relates to a sensor device that includes a wireless communication function, a server node that is an upper device of the sensor device, and an overall sensor network system including them. Particularly, the present invention relates to an arrangement and a method that allow a reduction in power consumption of the sensor device and therefore allow the sensor network system to operate over long periods.

### BACKGROUND OF THE INVENTION

As illustrated in FIG. 9, a sensor network system 100 is realized by a number of sensor devices (alternatively, the sensor devices may be realized by “sensor modules”) 101 . . . that include, among others, a wireless communication function. The sensor network system 100 is widely used in various fields such as crime prevention, nursing care, energy conservation, wide-area survey, and tracing. For example in nursing care, the sensor devices 101 are used in monitoring, for example, a pulse, body temperature, posture, movement of limbs, as well as emergency situations. Further, for example in construction, a sensor device B is used in monitoring earthquake data, movement of a supporting member of a construction, fire disaster, a flood and the like.

Sensor devices 101 are provided in a large area without overlapping with each other. Generally, the sensor devices 101 are provided in an area where no power source is available because of their functions. Therefore, the sensor devices 101 indispensably need low power consumption.

Conventionally, for example as taught in Japanese Unexamined Patent Publication No. 2005-31826 (published on Feb. 3, 2005), it has been attempted to reduce power consumption by providing a sensor device 101 with a function of monitoring a power source so that (i) operations of the sensor device 101 are controlled in response to power monitoring information derived from such a function of monitoring, and/or (ii) the power monitoring information is transmitted to the outside of the sensor device 101.

However, the conventional sensor device, the server node, the sensor network, and the method of controlling the sensor device have a problem of power loss due to power consumption caused by (i) the power monitoring function in the sensor device 101, (ii) the actual power monitoring, and (iii) the controlling operations of the sensor device 101.

Further, according to the arrangement of the sensor network system 100, in response to each request for receiving detected-data from a plurality of external applications 121, 122, 123 . . . detected-data, for example a sensor device (A) 101 needs to transmit to the external applications 121, 122, 123 . . . detected-data obtained via transmitting and receiving operations.

Specifically, as illustrated in FIG. 10, the sensor device (A) 101 (i) receives all the requests, in a form of message, from the external applications 121 and 123, and in response to the requests, (ii) supplies the external applications 121 and 123 with detected-data corresponding to the requests, respectively. Note that, even in a case where a server node is provided between the sensor device 101 and the external applications 121, 122, 123 . . . (though the server node is not described and illustrated), (i) the number of transmission and receiving of the messages and (ii) the number of detection, by the sensor device (A) 101, remain the same.

This way of response gives rise to a problem of increasing the power consumption of the sensor device 101.

### SUMMARY OF THE INVENTION

The present invention has as an object to provide a sensor device, a server node, a sensor network, and a method of controlling a sensor device that allow a reduction in power consumption of the sensor device by eliminating the power consumption on account of (i) receipt, transmission, and data detection by the sensor device, which are carried out each time an external application request for detected-data and (ii) a power-source monitoring function in the sensor device.

In order to solve the above problems, the sensor network system according to the present invention is adapted so that, in the sensor network system including (i) a server node that transmits and receives, via a network, a signal to/from an external device having one or plural external application and (ii) one or plural sensor device connected to the server node, the server node including sensor-device power-consumption controlling means for reducing a number of transmission from the one or plural sensor device, on the basis of request cycles at which the external application transmits a request for detected-data.

Further, in order to solve the above problems, the method of controlling a sensor device of a sensor network system according to the present invention is adapted so that the method including (i) a server node that transmits and receives, via a network, a signal to/from an external device having one or plural external application and (ii) one or plural sensor device connected to the server node, the method including the step of reducing a number of transmission from the one or plural sensor device, on the basis of request cycles at which the external application transmits a request for detected-data.

With the above invention, sensor-device power-consumption controlling means is provided to a server node, and the sensor-device power-consumption controlling means causes the sensor device to reduce transmission, according to a cycle at which the external applications request for detected-data. As such, power consumption of the sensor device is reduced.

Accordingly, it becomes possible to provide a sensor network and a method of controlling a sensor device that allow a reduction in power consumption of the sensor devices by eliminating the power consumption on account of receipt, transmission, and data detection by the sensor device, which are carried out each time the external applications request for detected-data.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a diagram illustrating an arrangement of a sensor network system according to an embodiment of the present invention.

FIG. 2 is a block diagram illustrating an arrangement of a sensor device of the sensor network system.

FIG. 3 is a block diagram illustrating an arrangement of a processor of the sensor device.

FIG. 4 is a block diagram illustrating an arrangement of a server node of the sensor network system.

FIG. 5 is a block diagram illustrating an arrangement of a processor of the server node.

FIG. 6 is an explanatory diagram illustrating operations of the sensor network system.

FIG. 7 is a flowchart illustrating operations of the sensor network system.

FIG. 8 is a diagram illustrating a series of operations of the sensor network system.

FIG. 9 is a diagram illustrating an arrangement of a conventional sensor network system.

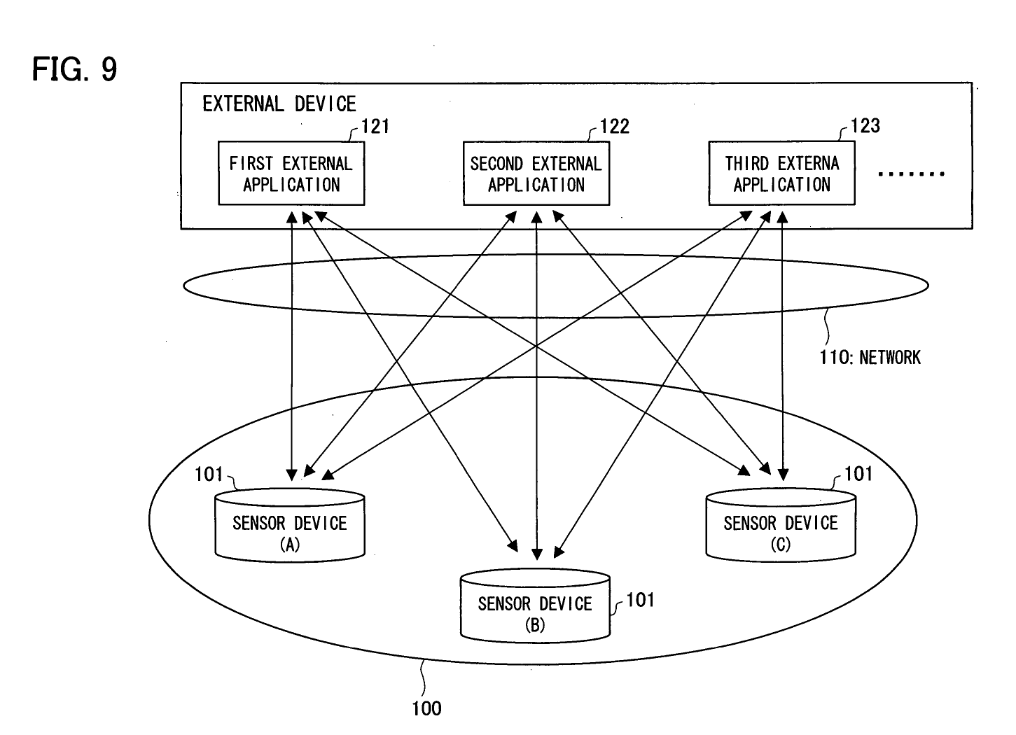

FIG. 10 is a diagram illustrating a series of operations of a conventional sensor network system.

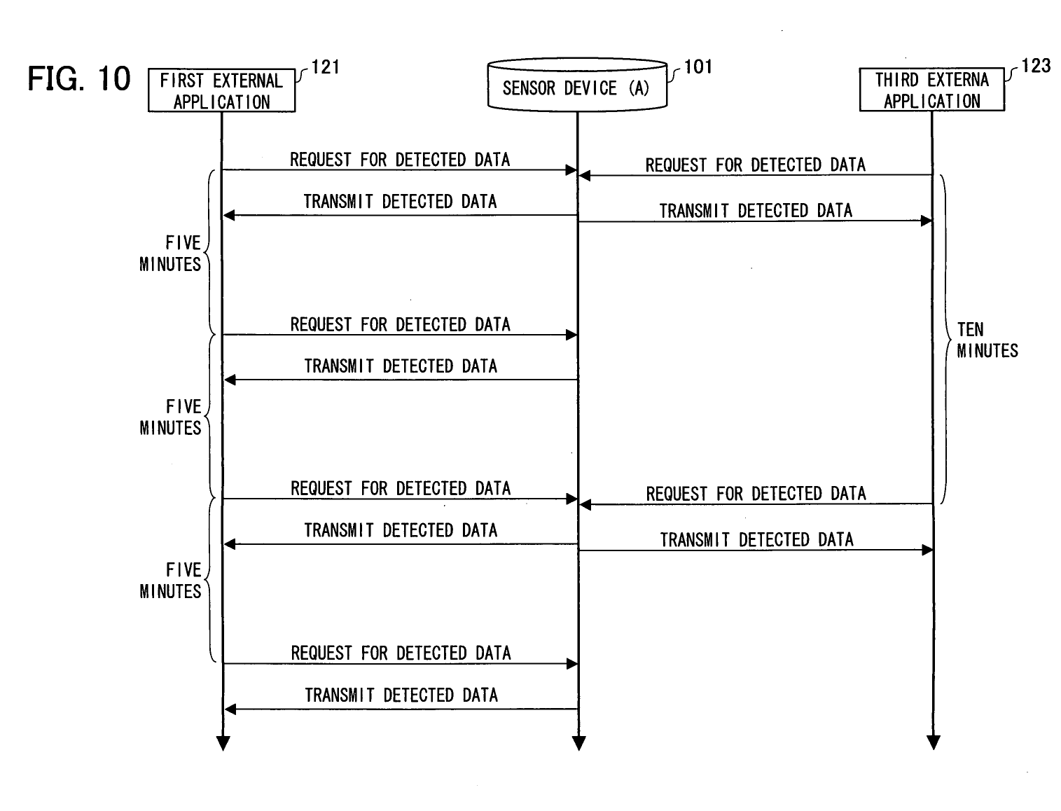

### DESCRIPTION OF THE EMBODIMENTS

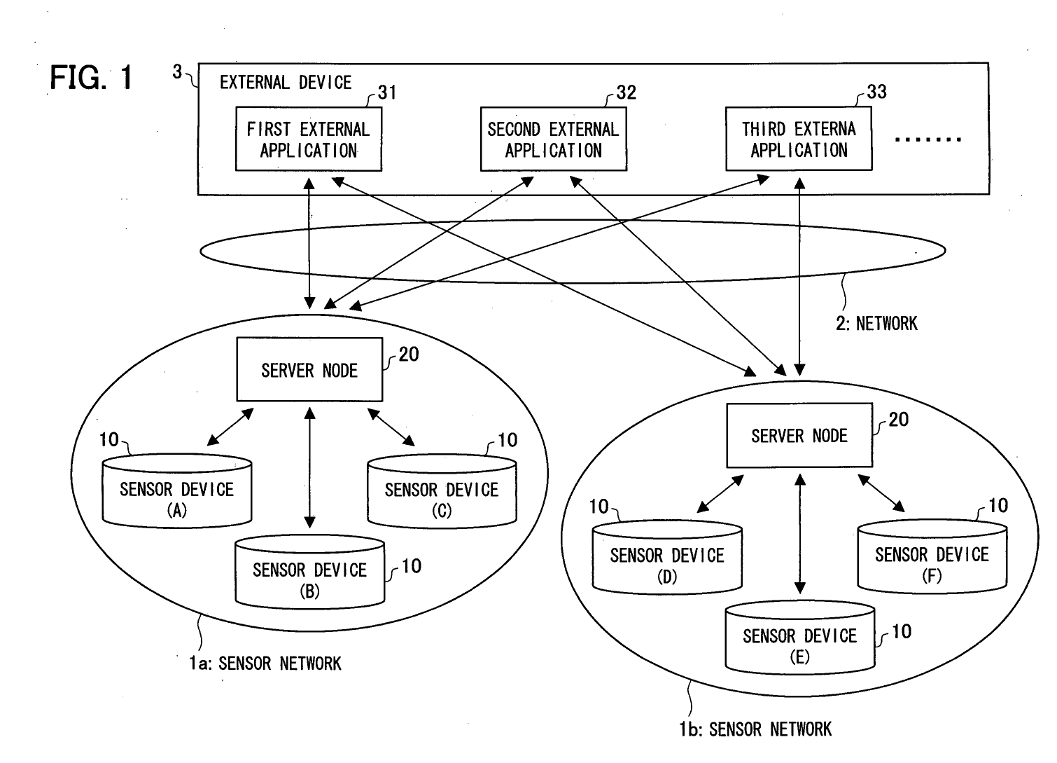

The following describes an embodiment of the present invention, with reference to FIGS. 1 to 8.

As illustrated in FIG. 1, a sensor network system 1a of the present embodiment is realized by sensor devices (A) 10 to (C) 10 and a server node 20. The respective sensor devices (A) 10 to (C) 10 include a plurality of sensors 16 that have a same function or different functions from each other. The sensors 16 will be specifically described below.

The sensor network system 1a is respectively connected to a first external application 31, a second external application 32, a third external application 33 . . . of an external device 3 via a network 2. The first external application 31, the second external application 32, the third external application 33 . . . operate for a same purpose or different purposes. For example, in the case of different purposes, the first external application 31 is for an application for home security, the second external application 32 is for an application for saving energy consumed at home, and the third external application 33 is for an application for nursing care. It is certainly possible to connect a fourth external application 34 and more.

Further, the network 2 is realized by a wireless network for communications between (i) the server node 20 and (ii) the first external application 31, the second external application 32, the third external application 33 . . . in the present embodiment. The network 2, however, is not limited to such a wireless network, and may be realized by a wire network.

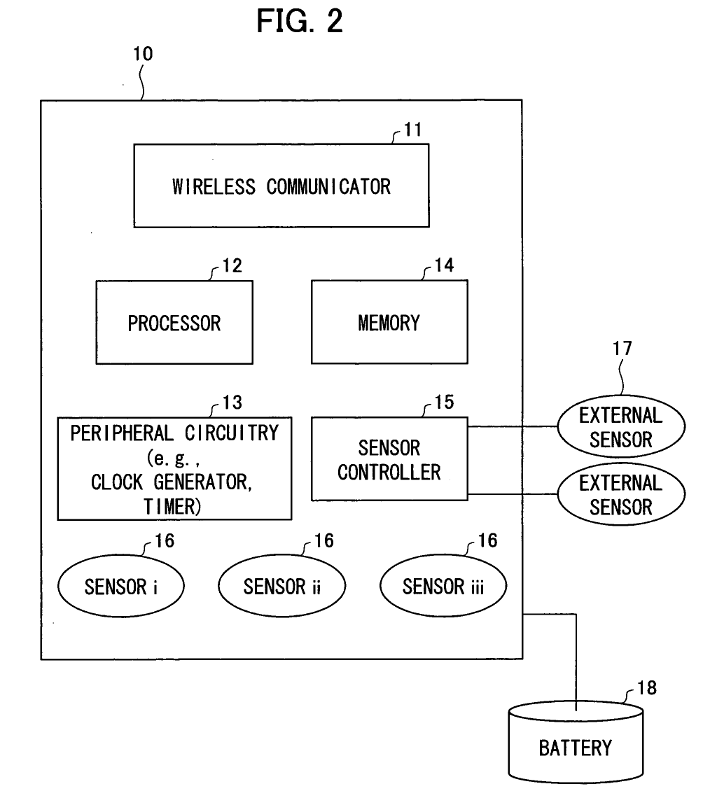

FIG. 2 illustrates an internal arrangement of the sensor device 10.

As illustrated in the figure, the respective sensor devices (A) 10 to (C) 10 include: a wireless communicator 11 for communicating with the server node 20; a processor 12; a peripheral circuitry 13; a memory 14 that acts as memory means; a sensor controller 15; sensors 16; external sensors 17; a battery 18 for the sensor devices (A) 10 to (C) 10.

The peripheral circuitry 13 includes functions such as a function of generating a clock for causing the processor 12 to operate, and a function of managing time. The memory 14, which is a storage medium, is utilized in carrying out loading one or a plurality of programs and is used during executing of a program. The memory 14 is also utilized in storing data transmitted from the server node 20.

The sensors 16 are realized by different kinds of sensors (e.g, sensor for temperature, sensor for humidity, sensor for detecting light). The external sensors 17 are realized by different kinds of external sensors. The sensors 16 and the external sensors 17 are controlled by the sensor controller 15.

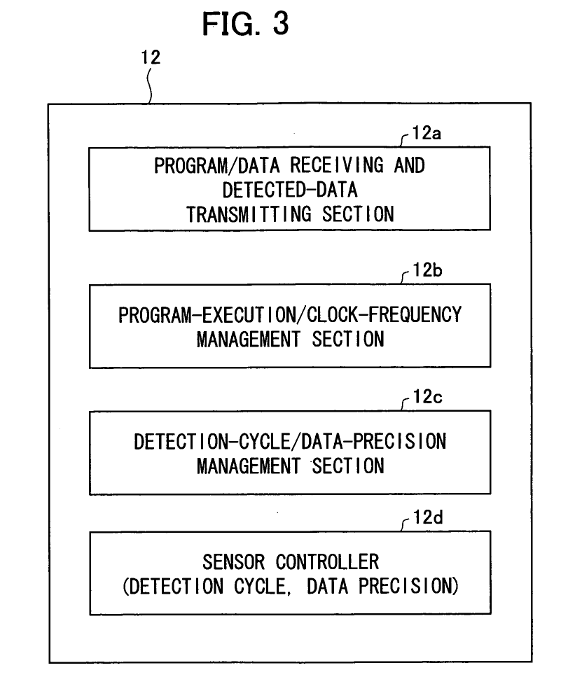

The processor 12 is realized by a CPU. The processor 12 (i) carries out loading a program and data transmitted from the server node 20, (ii) executes the program, and (iii) controls the peripheral circuitry 13 and the sensor controller 15. As illustrated in FIG. 3, the processor 12 includes controllers corresponding to respective purposes. Specifically, the processor 12 includes controllers such as: a program/data receiving and detected-data transmitting section 12a; a program-execution/clock-frequency management section 12b; a detection-cycle/data-precision management section 12c; and a sensor controller 12d. The sensor controller 12d controls a detection cycle and a data precision.

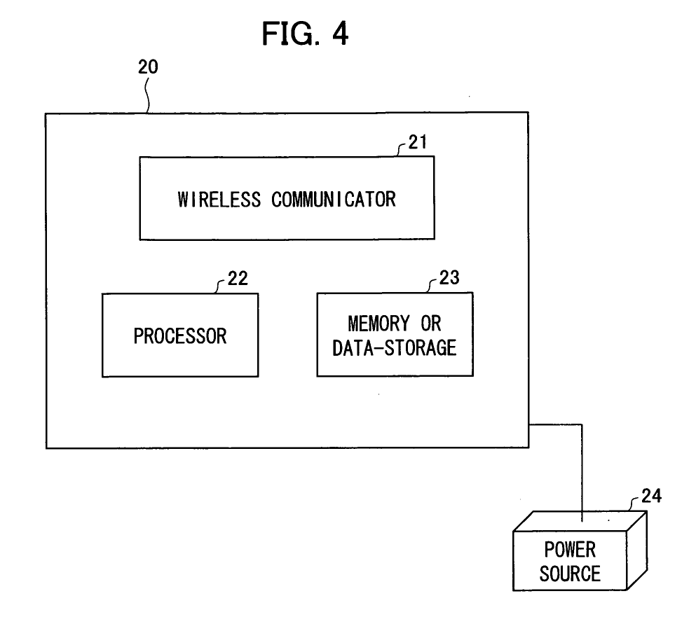

FIG. 4 illustrates an internal arrangement of the server node 20.

As illustrated in the figure, the server node 20 includes: a wireless communicator 21 (transmitting means) for communicating with the sensor devices (A) 10 to (C) 10, the first external application 31, the second external application 32, the third external application 33 . . . ; a processor 22 for performing various processes; a memory (or data storage) 23 (detected-data request accumulating means) for accumulating a program and data; and a power source 24. The processor 22 and the memory (or data storage) 23 function as sensor-device power-consumption controlling means of the present invention.

The power source 24 stably supplies the server node 20 with power in the present embodiment.

The processor 22 is realized by a CPU. The processor 22 (i) communicates with the first external application 31, the second external application 32, the third external application 33 . . . , (ii) performs processes in response to a request, and at the same time, stores and accumulates the results thus processed in the memory (or data storage) 23, which is an internal storage means, and (iii) analyzes the results. The processor 22 also performs a transmission process for controlling the sensor devices (A) 10 to (C) 10, and receives detected-data from the sensor device (A) 10 to (C) 10. Furthermore, the processor 22 stores and accumulates the detected-data in a memory (or data storage), and manages the detected-data.

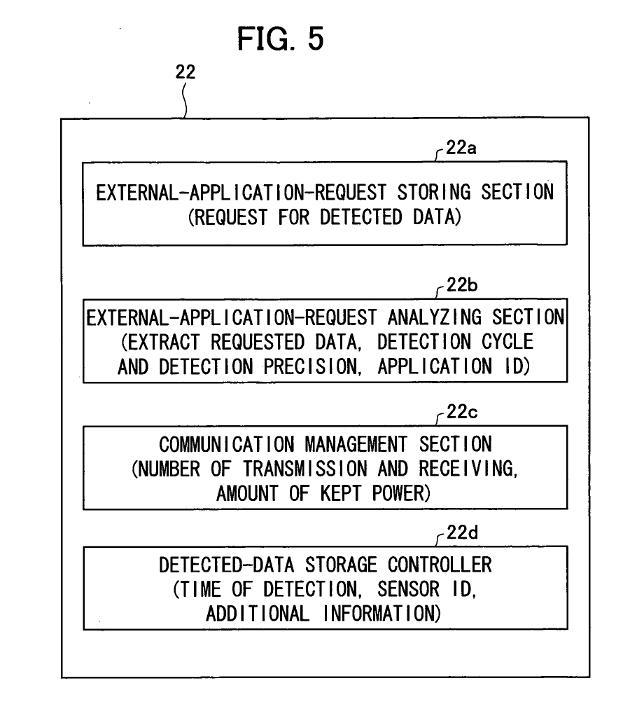

Specifically, as illustrated in FIG. 5, the processor 22 includes: an external-application-request storing section 22a that causes the memory (or data storage) 23 to store the detected-data requested by the first external application 31, the second external application 32, the third external application 33 . . . ; an

external-application-request analyzing section 22b (transmission-cycle controlling means) that extracts (i) necessary detected-data (ii) a detection cycle and a precision of detection and (iii) an application ID; a communication management section 22c (power-source managing means) that controls (i) the number of transmission and receiving and (ii) an amount power kept by the sensor devices (A) 10 to (C) 10; and a detected-data storage controller 22d that causes the memory (or data storage) 23 to store a detection time, a sensor ID, and additional information.

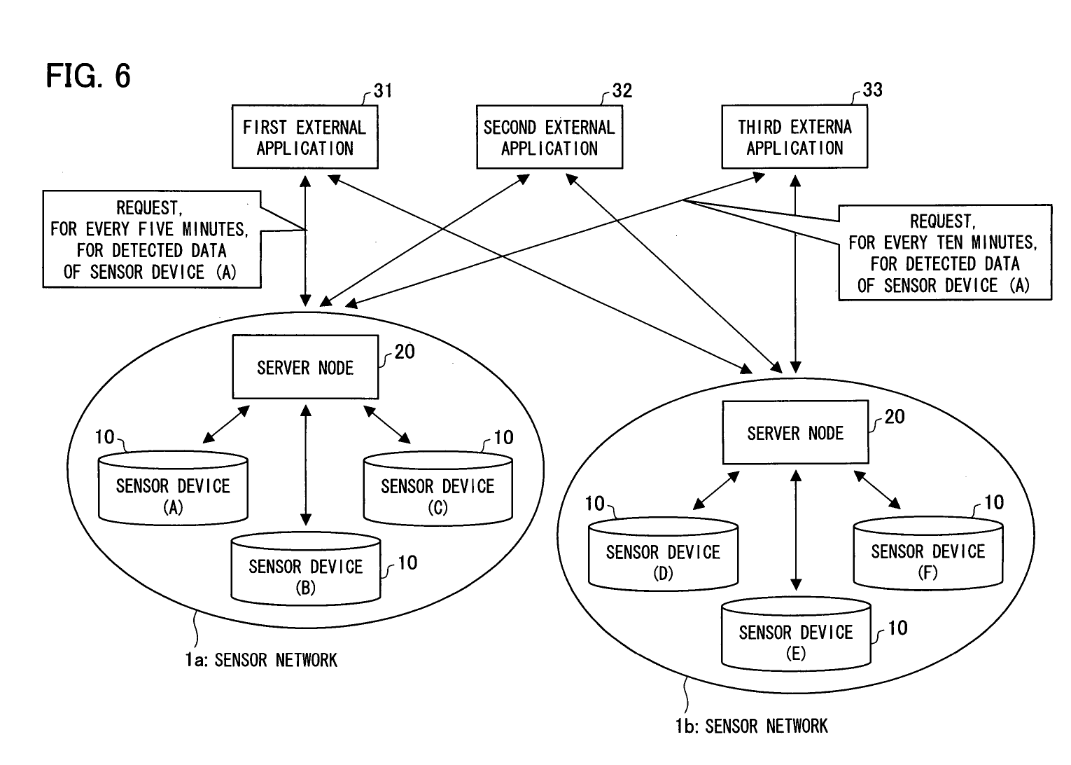

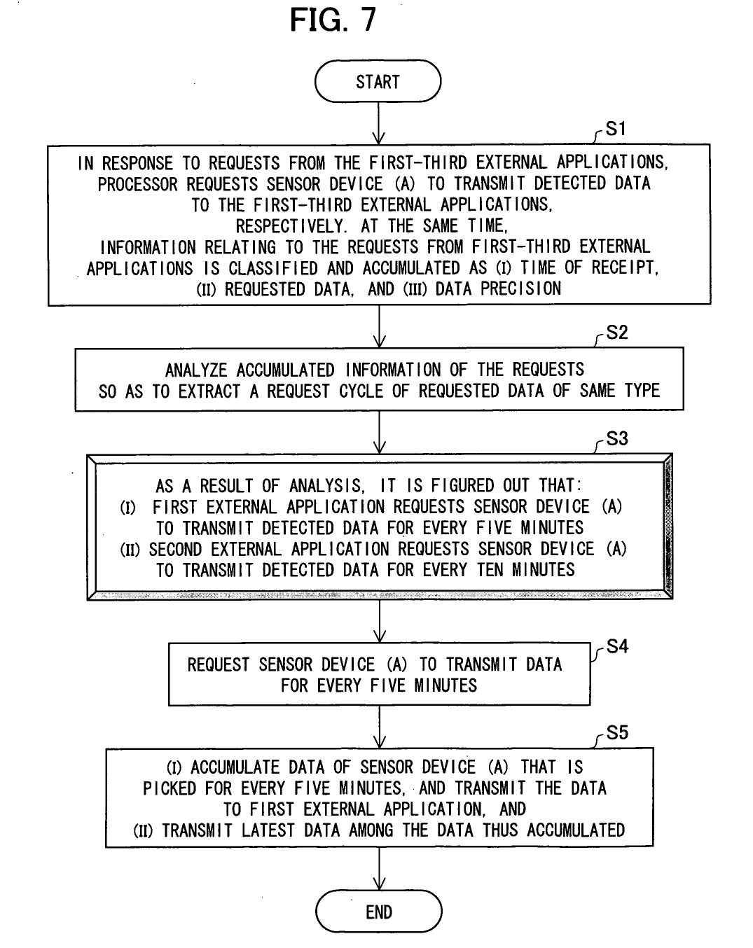

The following describes operations of the sensor network system 1a having the above described arrangement, with reference to FIGS. 6 and 7. FIG. 6 illustrates a case where (i) the first external application 31 requests, for every five minutes, the server node 20 of the sensor network system 1a to transmit detected-data of the sensor device (A) 10, and (ii) the third external application 33 requests, for every ten minutes, the server node 20 of the sensor network system 1a to transmit detected-data of the sensor device (A) 10. In other words, FIG. 6 shows that different external applications, i.e., the first external application 31 and the third external application 33, request the detected-data of the same sensor device (A) 10 at the different cycles.

In this case, the processor 22 of the server node 20 performs the processes as illustrated in the flowchart of FIG. 7.

As illustrated in the figure, in response to requests from the first-third external applications 31-33, the processor 22 appropriately requests the sensor device (A) 10 to transmit detected-data to the first-third external applications 31-33, respectively. At the same time, information relating to the requests from the first-third external applications 31-33 is classified and accumulated as (i) time of receipt, (ii) requested data, and (iii) data precision (S1). Thereafter, accumulated information of the requests is analyzed so as to extract a request cycle of requested data of same type (S2).

As a result of the analysis, it is figured out that the first external application 31 requests the sensor device (A) 10 to transmit detected-data for every five minutes, whereas the third external application 33 requests the sensor device (A) 10 to transmit detected-data for every ten minutes (S3).

Then, the processor 22 requests the sensor device (A) 10 to transmit data for every five minutes (S4). Thereafter, the data picked for every five minutes by the sensor device (A) 10 is accumulated and transmitted to the first external application 31, whereas the latest data among the data thus accumulated is transmitted to the third external application 33 (S5).

Steps S1, S2, S4, and S5 indicate processes performed by the processor 22 of the server node 20. On the other hand, step S3 indicates a result of the process performed in S2. In step 3, found are the periodicities of the requests of the first external application 31 and the third external application 33.

This result indicates that it is sufficient to transmit the detected-data, which has been accumulated in the server node 20, in response to the request of the third external application 33, whose cycle is longer, and therefore it is unnecessary to actually request the sensor device (A) 10 to transmit the detected-data.

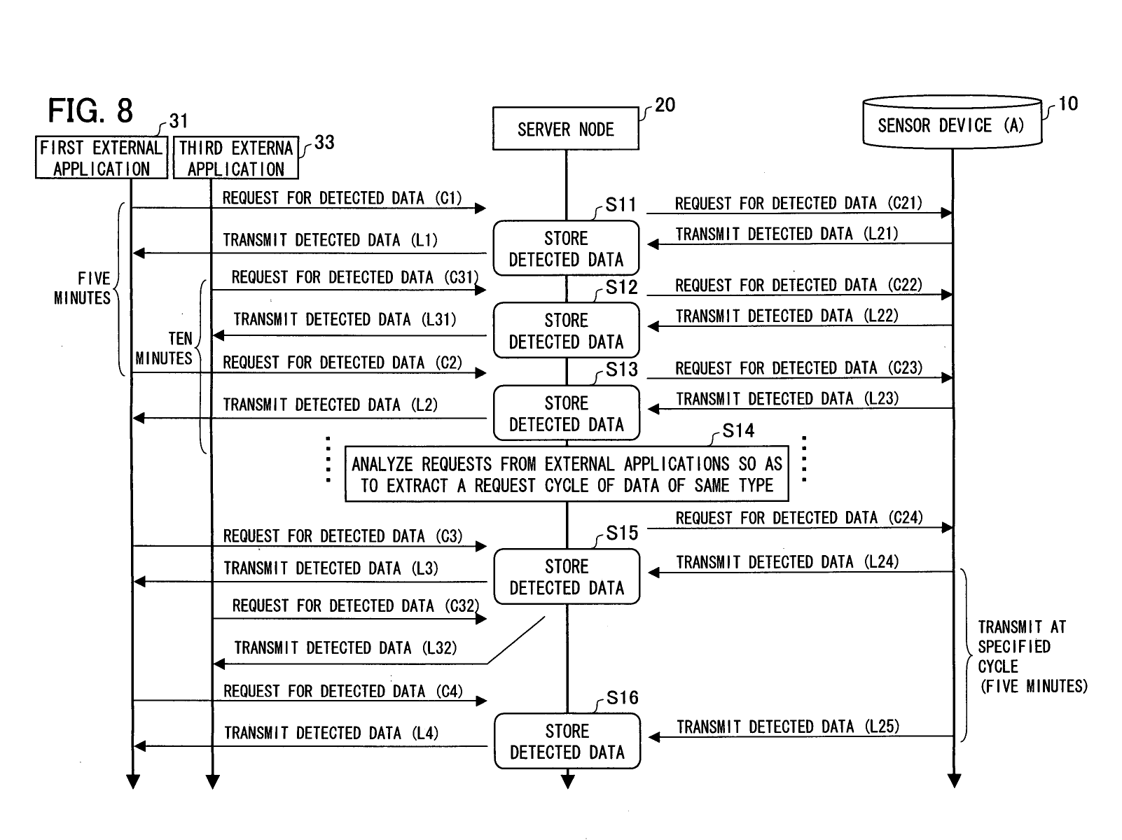

The following describes a flow of concrete processes performed in the sensor network system 1a of the present embodiment, with reference to FIG. 8. FIG. 8 chronologically illustrates processes performed by the first external application 31, the third external application 33, the server node 20, and the sensor device (A) 10.

As illustrated in the figure, the first external application 31 transmits, for every five minutes, a message to the server node 20 so as to request detected-data of the sensor device (A) 10 (C1 to C4). In response to the requests (C1, C2), the server node 20 immediately transmits a message to the sensor device (A) 10 so as to request the detected-data (C21, C23). In response to the requests (C21, C23), the sensor device (A) 10 transmits detected-data to the server node 20 (L21, L23). The server node 20 stores the detected-data in the memory (or data storage) 23 (S11, S13), and then transmits the detected-data to the first external application 31 (L1, L2).

On the other hand, the third external application 33 transmits, for every ten minutes, a message to the server node 20 so as to request detected-data of the sensor device (A) 10 (C31, C32). In response to the request (C31), the server node 20 immediately transmits a message to the sensor device (A) 10 so as to request the detected-data (C22). In response to the request (C22), the sensor device (A) 10 transmits detected-data to the server node 20 (L22). The server node 20 stores the detected-data in the memory (or data storage) 23 (S12), and then transmits the detected-data to the third external application 33 (L31).

After storing the detected-data in S13, the server node 20 analyzes the requests for detected-data from the first external application 31 and the third external application 33 so as to extract a cycle of data of same type (S14). Thereafter, the server node 20 notifies the sensor device (A) 10 of thus extracted cycle of the requests for detected-data from the first external application 31 and the third external application 33 (C24).

When receiving the message, the sensor device (A) 10 changes, in accordance with an instruction from the server node 20, the transmission cycle at which the sensor device (A) 10 transmits data to the server node 20. Thereafter, the sensor device (A) 10 transmits detected-data to the server node 20 at the transmission cycle thus changed (L24, L25). The server node 20 stores and accumulates, in the memory (or data storage) 23, the detected-data transmitted from the sensor device (A) 10 (S15, S16). Specifically, in the present case where the first external application 31 requests detected-data for at least every five minutes (minimum cycle is five minutes), the sensor device (A) 10 sets the transmission cycle at five minutes and transmits, for every five minutes, detected-data to the server node 20 (L24, L25).

Therefore, when receiving, for every five minutes, a message of requesting detected-data of the sensor device (A) 10 from the first external application 31 (C3 to C4), the server node 20 has already stored, in the memory (or data storage) 23, the detected-data that had been transmitted, for every five minutes, from the sensor device (A) 10. As such, the server node 20 transmits the detected-data thus stored to the first external application 31 (L3, L4).

On the other hand, when receiving, for every ten minutes, a message of requesting detected-data of the sensor device (A) 10 from the third external application 33 (C32), the server node 20 has already stored, in the memory (or data storage) 23, the detected-data that had been transmitted, for every five minutes, from the sensor device (A) 10 as described above. For this reason, the server node 20 transmits the detected-data thus stored to the third external application 33 (L32).

It is apparent from the above-described process that the sensor device (A) 10 operates periodically, and therefore (i) the server node 20 does not need to transmit a message of requesting detected-data to the sensor device (A) 10, (ii) the sensor device (A) 10 does not need to detect the message from the third external application 33 (C32), and (iii) the sensor device (A) 10 does not need to transmit requested data. It is easily understood therefrom that the number of operations of the sensor device (A) 10 and the number of transmission and receiving of messages by the sensor device (A) 10 are reduced consequently.

In the present case, it is no longer necessary for the sensor device (A) 10 to transmit detected-data in response to a request (C32) for detected-data from the first external application 31 (C3 to C4) and the third external application 33. This reduces 75% of power consumption.

As described above, in the arrangement of the server node 20, the sensor network system 1a, and the method of controlling the sensor device according to the present embodiment, the server node 20 includes (i) the memory (or data storage) 23 for responding to a request from the first external application 31, the second external application 32, the third external application 33 . . . , and at the same time, accumulating the content of the request, and (ii) the memory (or data storage) 23 for accumulating detected-data transmitted from the sensor devices (A) 10 to (C) 10.

It is unavoidable that the sensor devices (A) 10 to (C) 10 are driven by the battery 18, while the server node 20 stably receives power from the power source 24.

The server node 20 (i) analyzes the requests from the first external application 31, the second external application 32, the third external application 33 . . . and (ii) accumulates an application ID, a time of receipt, and a type of requested detected-data, as minimum information. When necessary, a detected-data precision may also be accumulated so that the power consumptions of the sensor devices (A) 10 to (C) 10 are controlled more minutely. The amount of information to be accumulated may be changed depending upon a capacity of the memory (or data storage) 23 provided in the server node 20. Furthermore, in order to further reduce a memory capacity, repeatedly-made requests of a same type may be converted into cycle information. By this way, the data can be managed while being compressed.

Further, the server node 20, the sensor network system 1a, and the method of controlling the sensor device according to the present embodiment include an external-application-request analyzing section 22b that (i) manages and analyzes the requests for detected-data from the first external application 31, the second external application 32, the third external application 33 . . . , which requests have been accumulated in the server node 20, (ii) responds to all requests for detected-data from the first external application 31, the second external application 32, the third external application 33 . . . , and (iii) extracts an operation parameter with which the operations of the sensor devices (A) 10 to (C) 10 are minimized.

The operation parameters thus extracted (i.e., the detection cycle and the data precision) are transmitted to the respective sensor devices (A) 10 to (C) 10. Supplied detected-data is accumulated in the memory (or data storage) 23 in the server node 20. The detected-data thus accumulated is transmitted to the first external application 31, the second external application 32, the third external application 33 . . . , when necessary.

The extraction is carried out by placing importance on regularity. Requests of a same type are grouped in a form of a cycle, and this is carried out for each of the first external application 31, the second external application 32, the third external application 33 . . . Note that, in the case where a plurality of external applications (first external application 31, second external application 32, third external application 33 . . . ) periodically transmit requests for the same detected-data, respectively, (i) the sensor devices (A) 10 to (C) 10 are set at a shorter cycle, (ii) detected-data is picked at this cycle, and (iii) the detected-data is accumulated in the server node 20, and at the same time, transmitted to the first external application 31, the second external application 32, the third external application 33 . . . that request for the detected-data at the shorter cycle.

Accumulated in the server node 20 are a time of receipt of detected-data, a sensor device ID, and detected-data. How much to accumulate is changed depending upon the capacity of the memory (or data storage) 23 in the server node 20. When overflow occurs, the information may be erased, from the oldest information first (the oldest information is erased first). Note that, in response to a request from an external application that transmits a request at a longer cycle (for example, the third external application 33), the latest data among the detected-data thus accumulated in the server node 20 is transmitted to the third external application 33. By this way, the sensor devices (A) 10 to (C) 10 are allowed to omit (i) receipt of requests for detected-data, which requests are periodically transmitted from the server node 20, and (ii) transmission of detected-data to the external application that transmits a request at the longer cycle. This allows a reduction in power consumption of the sensor devices (A) 10 to (C) 10.

On the other hand, in the case where the requests from the first external application 31, the second external application 32, the third external application 33 . . . are not transmitted periodically, it is necessary to accordingly (i) receive a request for detected-data of the sensor devices (A) 10 to (C) 10 and (ii) transmit the detected-data. Even in this case, however, if the time difference between (i) the time of receipt of the detected-data, which is accumulated in the server node 20 and (ii) the time of request from the first external application 31, the second external application 32, the third external application 33 . . . is within a specified period of time, then it is still possible to reduce power consumption of the sensor devices (A) 10 to (C) 10 by reducing the number of data-transmission and data-receiving, for example by transmitting accumulated data.

Further, the communication management section 22c of the server node 20 records transmission and receipt by the respective sensor devices (A) 10 to (C) 10. On the basis of the records, the communication management section 22c calculates power consumption of the respective sensor devices (A) 10 to (C) 10.

Specifically, the communication management section 22c of the server node 20 records (i) the time when the respective sensor devices (A) 10 to (C) 10 are newly installed and (ii) transmission and receipt by the respective sensor devices (A) 10 to (C) 10. At the time of installation, electric energies of the respective sensor devices (A) 10 to (C) 10 are set at specified values that are predetermined for the respective sensor devices (A) 10 to (C) 10. It is also possible to set, at a specified value, a power consumption necessary for (i) one detection, (ii) one transmission, and (iii) one receipt. Then, an electric energy under control is updated each time the respective sensor devices (A) 10 to (C) 10 perform detection, transmission, or receipt.

With the above arrangement, power consumption of the sensor devices (A) 10 to (C) 10 is managed by the server node 20 which receives power in a stable manner. This allows the sensor device (A) 10 to (C) 10 to omit a power-source management function, and therefore avoid a power loss due to power management. As such, a reduction is achieved in power consumption of the sensor devices (A) 10 to (C) 10. Furthermore, the number of transmission and receipt by the sensor devices (A) 10 to (C) 10 is reduced, and therefore a reduction is achieved in power consumption of the sensor devices (A) 10 to (C) 10.

Note that, although only the sensor network system 1a illustrated in FIG. 1 is described in the present embodiment, the same effects as of the sensor network system 1a are also achieved by the sensor network system 1b that includes (i) a server node 20 and (ii) sensor devices (D) 10 to (F) 10 with sensors 16 having same or different functions, as illustrated in the figure.

As described above, the sensor device, the server node, and the sensor network according to the present invention are adapted. The server node transmits and receives, via a network, a signal to/from an external device including one or plural external application. The sensor device includes (a) a wireless communicator for transmitting and receiving a signal to/from the server node, (b) a memory for storing a program and data that are transmitted from the wireless communicator, (c) a processor for executing the program, (d) a peripheral circuitry for supporting the processor, (e) one or plural sensor controlled in accordance with the program, and (e) a sensor controller for controlling the sensor. The sensor network system including the server node and one or plural sensor device mentioned above. In the server node, the sensor device, and the sensor network system, the power consumption of the sensor device is controlled by (i) accumulating, in the server node, detected-data transmitted from the sensor device and managing the detected-data thus accumulated and (ii) transmitting the detected-data thus accumulated in the server node in response to a request for detected-data from the plural applications.

Further, in the server node and the sensor network according to the present invention, there is provided a memory function or a data storage function for storing (i) detected-data transmitted from one or plural sensor device and (ii) a time of detection, a sensor ID, and additional information. In the server node and the sensor network, detection and transmission of data by the sensor device are controlled by (i) accumulating, managing, and analyzing the requests from the external application so as to extract a type of requested detected-data and a cycle of the requests and (ii) transmitting a detected-data transmission cycle (cycle at which detected-data is transmitted to the sensor device) and a detected-data precision.

Further, in the server node and the sensor network according to the present invention, (i) the number of transmission to one or plural sensor device and (ii) the number of receipt from the sensor device are managed. By doing so, power consumption of the respective sensor devices is managed without providing a power-source management function in the sensor device.

Further, in the sensor device, the server node, and the sensor network according to the present invention, with regard to a cycle at which the sensor device transmits detected-data to the server node (detected-data transmission cycle), the server node transmits cycle data to the sensor device when the detected-data transmission cycle needs to be changed so as to conform with a request from the external application. By this way, the detected-data transmission cycle is controlled.

Further, in the sensor device, the server node, and the sensor network according to the present invention, the cycle is reset to a default, without a request from the server node, after a predetermined period of time has passed since the detected-data transmission cycle was changed.

Further, in the sensor device, the server node, and the sensor network according to the present invention, with regard to the precision of detected-data supplied to the sensor node from the sensor device, if the detected-data precision needs to be changed so as to conform with a precision requested by the external applications, then the server node transmits a detected-data precision to the sensor devices. This is followed by (i) selecting, or changing to, a sensor operation program corresponding to the detected-data precision thus transmitted, or (ii) executing a program with the use of the detected-data precision as a parameter, so that the detected-data precision is changed. By this way, the power consumption is controlled.

Further, in the sensor device, and the sensor network according to the present invention, the precision is reset to a default, without a request from the server node, after a predetermined period of time has passed since the detected-data precision was changed.

Further, in the sensor device, the server node, and the sensor network according to the present invention, with regard to a cycle at which the sensor device transmits detected-data to the server node (detected-data transmission cycle), the server node transmits cycle data to the sensor device when the detected-data transmission cycle needs to be changed so as to conform with a cycle requested by the external application. By doing so, (i) a clock frequency of the processor in the sensor device and (ii) a clock frequency of the peripheral circuitry of the processor are changed to a minimum frequency that is sufficient for the cycle requested by the server node.

Further, in the sensor device, and the sensor network according to the present invention, (i) the clock frequency of the processor in the sensor device and (ii) the clock frequency of the peripheral circuitry of the processor are reset to a default, without a request by the server node, after a predetermined period of time has passed since the detected-data transmission cycle was changed.

Further, in the sensor device, and the sensor network according to the present invention, with regard to storing, in the sensor device, the program supplied to the sensor device from the server node, the memory in the sensor device is allowed to store one or plural program, and a program is selected from the stored ones, in accordance with the request by the server node. By this way, the power consumption is controlled.

Further, the sensor device according to the present invention controls power consumption of the sensor device that is in operation, by rewriting, in accordance with data transmitted from the server node, a rewritable sensor controlling circuit of the sensor device.

Further, in the method of controlling a sensor device of a sensor network system according to the present invention, the server node performs the following processes: accumulating and managing requests from one or plural external application; analyzing the requests so as to extract a type, a precision, and a cycle of detected-data that is requested; optimizing the requests in such a way as to (i) correspond, with the use of information thus extracted, to all requests made by the applications and (ii) minimize the number of transmission and receipt to/from the sensor devices; transmitting, to the sensor device, a detected-data transmission cycle and a precision of the detected-data; and transmitting one or plural program to the sensor device.

Further, the method of controlling a sensor device of a sensor network system according to the present invention includes the steps of: storing, in the memory, one or plural program transmitted to the sensor devices from the server node; selecting a program that is to be executed with the use of (i) a detected-data transmission cycle and (ii) information of data-precision, both of which are transmitted from the server node, or alternatively, executing a program using, as arguments, cycle data and precision information; and transmitting detected-data.

Further, the method of controlling a sensor device of a sensor network system according to the present invention includes the step of controlling, in accordance with cycle data transmitted from the server node, the clock frequency of the processor such that the power consumption is minimized.

Further, in the method of controlling a sensor device of a sensor network system according to the present invention, if no cycle data or information of precision of detected-data has been transmitted from the server node for a predetermined period of time, then the cycle and the precision are reset to a default. By this way, the power consumption is controlled.

Further, in the method of controlling a sensor device of a sensor network system according to the present invention, (i) the number of transmission to the sensor devices by the server node and (ii) the number of receipt by the server node from the sensor devices are managed. This makes it possible to figure out the power consumption of the sensor devices. As such, it becomes possible to control, on the basis of a level of the power consumption by the sensor devices, the detected-data transmission cycle and the data precision that are to be transmitted to the sensor devices.

The present invention relates to a sensor device that includes a wireless communication function, a server node which is on a higher level than the sensor device, and a sensor network system encompassing all of them. The sensor network system includes a number of sensor devices, or sensor modules, that have a wireless communication function. The sensor network system may be used for various purposes in various fields including crime-prevention, nursing care, energy conservation, wide-area survey, trace and the like.

It is preferable in the sensor network system of the present invention that the sensor-device power-consumption controlling means of the server node include: detected-data request accumulating means for accumulating the request for detected-data from the external application; transmission-cycle controlling means for (i) analyzing the request cycles so as to extract (a) detection cycles at which the one or plural sensor device needs to detect detected-data and (b) transmission cycles at which the detected-data needs to be transmitted to the server node and (ii) instructing the one or plural sensor device to (a) detect detected-data at the detection cycles thus extracted and (b) transmit the detected-data at the transmission cycles thus extracted; storage means for storing detected-data that is transmitted from the one or plural sensor device to the server node at the transmission cycles thus extracted; and transmitting means for transmitting the detected-data thus stored, in response to a request for detected-data from the external application.

Further, it is preferable in the method of controlling a sensor device of a sensor network system of the present invention that the server node: accumulate the request for detected-data from the external application; (i) analyze the request cycle so as to extract (a) a detection cycle at which the one or plural sensor device needs to detect detected-data and (b) a transmission cycle at which the detected-data needs to be transmitted to the server node and (ii) instruct the one or plural sensor device to (a) detect detected-data at the detection cycle thus extracted and (b) transmit the detected-data at the transmission cycle thus extracted; store detected-data that is transmitted from the one or plural sensor device to the server node at the cycle thus extracted; and transmit the detected-data thus stored, in response to a request for detected-data from the external application.

According to the invention above, the server node accumulates, in the detected-data request accumulating means, the requests for detected-data by the external applications. Then, the transmission-cycle controlling means (i) analyzes a request cycle of the requests for detected-data by the external applications so as to extract (a) a detection cycle at which the sensor device needs to detect data and (b) a transmission cycle at which detected-data needs to be transmitted to the server node and (ii) instructs the sensor device to (i) detect data at the detection cycle thus extracted and (ii) transmit detected-data at the transmission cycles thus extracted.

This allows the sensor device to (i) detect data at a data-detection cycle instructed by the server node and (ii) transmit detected-data at a transmission cycle instructed by the server node.

Then, the detected-data transmitted to the server node from the sensor device is stored in the storage means of the server node, and then transmitted from the server node to the external applications by transmitting means.

Specifically, for example in a case where an external application requests detected-data for every five minutes, if the server node notifies the sensor device of this state, then, thereafter, the sensor device detects and transmits data to the server node for every five minutes, although the server node does not transmit to the sensor device a request for detected-data from the external applications.

This allows the sensor device to avoid receiving a request for detected-data from the server node when the server node receives the request from the external applications. Therefore, it becomes possible to save power consumption for the receiving.

Accordingly, it becomes possible to eliminate the power consumption on account of the receipt of a request by the sensor device, which is carried out each time the external applications request for detected-data.

On the other hand, suppose that, for example, (i) a cycle at which an external application requests for detected-data is five minutes, (ii) a cycle at which another external application requests for detected-data is 10 minutes, and (iii) timings of the respective requests are slightly different from each other.

In this case, although the server node does not transmit to the sensor device a request for detected-data from the external application when receiving the request, the sensor device detects and transmits, for every five minutes, data to the server node, as described above.

In response to the request from that another external application, the server node transmits to that another external application the detected-data thus transmitted, for every five minutes.

With the above arrangement, in the case where the server node receives, for every ten minutes, a request for detected-data from that another external application, the sensor device no longer needs to (i) receive the request from the server node, (ii) transmit detected-data, and (iii) detect data.

Accordingly, it becomes possible to eliminate the power consumption on account of (i) the receipt and transmission and (ii) detection of data by the sensor device, which are carried out each time the external applications request for detected-data.

Further, it is preferable in the sensor network system according to the present invention that the transmission-cycle controlling means of the server node include: power-source managing means for managing (i) a number of transmission to the one or plural sensor device and (ii) a number of receipt from the one or plural sensor device, so as to manage a power source of the one or plural sensor device.

Further, it is preferable in the method of controlling a sensor device of a sensor network system according to the present invention that the server node manage (i) a number of transmission to the one or plural sensor device and (ii) a number of receipt from the one or plural sensor device, so as to manage a power source of the one or plural sensor device.

According to the above invention, the power-source managing means of the server node manages (i) the number of transmission to the respective sensor devices and (ii) the number of receipt from the sensor devices, so as to manage the power sources of the respective sensor devices. Accordingly, it is not necessary to include a power-source management function in one or plural sensor devices.

Accordingly, it becomes possible to provide a sensor network and a method of controlling a sensor device that allow a reduction in power consumption of the sensor devices by eliminating power consumption on account of a power-source monitoring function in the sensor device.

Further, it is preferable in the sensor network system according to the present invention that the transmission-cycle controlling means of the server node transmit the transmission cycles thus extracted to the one or plural sensor device, when the transmission cycles of the one or plural sensor device needs to be changed so as to conform with the request cycles at which the external application requests detected-data.

Further, it is preferable in the method of controlling a sensor device of a sensor network system according to the present invention that the server node transmit the transmission cycles thus extracted to the one or plural sensor device, when the transmission cycle of the one or plural sensor device needs to be changed so as to conform with the request cycle at which the external application requests detected-data.

Suppose that, for example, (i) the sensor device receives, via the server node, a request for detected-data from an external application at a ten-minute cycle, (ii) the sensor device transmits, via the server node, detected-data to the external applications at the ten-minute cycle, and (iii) the server node receives a request for detected-data from another external application at a five-minute cycle. In this case, the detected-data transmission cycle of the sensor device needs to be changed so as to conform with the cycle at which the server node receives a request for detected-data from that another external application.

According to the present invention, in the case where a detected-data transmission cycle of the sensor device needs to be changed so as to conform with the cycle at which the server node receives a request for detected-data from the external application, the server node (i) extracts a request cycle from the request for detected-data from another external application, and (ii) transmits the five-minute cycle, which is the request cycle thus extracted, to the sensor device.

In this arrangement, when there is a change in the request cycle, the server node analyzes the change and then notifies the sensor device of an appropriate detected-data transmission cycle. Therefore, the sensor device no longer needs to (i) receive a request, (ii) detect data, and (iii) transmit data, in response to each request for detected-data from the external applications. Accordingly, it becomes possible to eliminate the power consumption on account of receipt, transmission, and data detection by the sensor device.

Further, it is preferable in the sensor network system according to the present invention that the one or plural sensor device, after instructed by the server node to change the transmission cycles, transmit detected-data to the server node at the transmission cycles thus changed, without receiving a request for transmitting detected-data, the request being transmitted at a same cycle as the transmission cycles.

Further, it is preferable in the method of controlling a sensor device of sensor network system according to the present invention that the one or plural sensor device transmit, after instructed by the server node to change the detected-data transmission cycle, detected-data to the server node at the transmission cycle thus changed, without receiving a request for transmitting detected-data, the request being transmitted at a same cycle as the transmission cycle.

According to the invention above, the sensor device transmits, after instructed by the server node to change the detected-data transmission cycle, detected-data to the server node at the detected-data transmission cycle thus changed, without receiving a request for transmitting detected-data, the request being transmitted at the same cycle as the cycle thus changed by the server node.

With this arrangement, for example in a case where (i) one external application requests, for every five minutes, the server node for detected-data, and (ii) another external application requests, for every ten minutes, the server node for detected-data, the sensor device no longer needs to (i) receive the request for detected-data from that another external application, (ii) detect data, and (iii) transmit detected-data.

Accordingly, it becomes possible to eliminate the power consumption on account of the receipt of a request, the detection of data, and transmission of the data by the sensor device, which is carried out each time the external applications request for detected-data.

Further, it is preferable in the sensor network system according to the present invention that the transmission-cycle controlling means of the server node transmit, to the one or plural sensor device, a detected-data precision to be changed, when (i) the server node receives a request from the external application regarding a detected-data precision and (ii) the detected-data precision of the one or plural sensor device needs to be changed so as to conform with the detected-data precision that is requested.

Further, it is preferable in the method of controlling a sensor device of a sensor network system according to the present invention that the server node transmit, to the one or plural sensor device, a detected-data precision to be changed, when (i) the server node receives a request from the external application regarding a detected-data precision and (ii) the detected-data precision of the one or plural sensor device needs to be changed so as to conform with the detected-data precision that is requested.

Suppose that, for example, while the sensor device (i) receives, via the server node, a request by an external application for detected-data with a precision of 1-decimal-place significant digit, and (ii) transmits, via the server node, detected-data with a precision of 1-decimal-place significant digit to the external applications, the server node receives a request for detected-data with a precision of 2-decimal-place significant digit by another external application. In this case, the detected-data precision of the sensor device needs to be changed to 2-decimal-place significant digit so as to conform with the detected-data precision requested by that another external application.

According to the present invention, in the case where the detected-data precision of the sensor device needs to be changed so as to conform with a detected-data precision requested by an external application, the server node (i) extracts a detected-data precision requested by the external application and (ii) transmits to the sensor device the precision thus extracted, which is 2-decimal-place significant digit.

In this arrangement, when there is a change in the detected-data precision requested by the external application, the server node analyzes that and then notifies the sensor device of an appropriate requested detected-data precision. Therefore, the sensor device no longer needs to receive a precision thus changed each time the external applications request for detected-data with a changed precision. Accordingly, it becomes possible to eliminate the power consumption on account of the receipt by the sensor device.

Further, generally, high-precision detection requires a longer operation time of a detection circuit. This causes the operation time of the sensor device to become longer. As a result, power consumption of the sensor device increases.

According to the present invention, when there is a change in the detected-data precision requested by the external application, the server node analyzes that and then notifies the sensor device of an appropriate requested detected-data precision. This allows the sensor device to select, or change to, a sensor operation program corresponding to the precision that is requested. Therefore, by detecting data in such a way as to avoid overquality compared to the precision that is requested, power consumption of the sensor device can be reduced.

Further, it is preferable in the sensor network system according to the present invention that the one or plural sensor device transmit, after instructed by the server node to change the detected-data precision, detected-data with the detected-data precision thus changed, without receiving again a request from the server node regarding the detected-data precision thus changed.

Further, it is preferable in the method of controlling a sensor device of a sensor network system according to the present invention that the one or plural sensor device transmit, after instructed by the server node to change the detected-data precision, detected-data of the detected-data precision thus changed, without receiving again a request from the server node regarding the detected-data precision thus changed.

According to the invention above, the sensor device transmits, after instructed by the server node to change the detected-data precision, detected-data with the detected-data precision thus changed, without receiving again a request from the server node regarding the detected-data precision thus changed.

With this arrangement, for example in a case where (i) an external application requests the server node for detected-data with a precision of 2-decimal-place significant digit and (ii) another external application requests the server node for detected-data with a precision of 1-decimal-place significant digit, the sensor device needs to neither receive the request for detected-data from that another external application nor transmit detected-data.

Accordingly, it becomes possible to eliminate the power consumption on account of the receipt of a request, the detection of data, and transmission of the data by the sensor device, which is carried out each time the external applications request for detected-data.

Further, the sensor device can select or change, in accordance with an instruction by the server node to change the detected-data precision, the sensor operation program, depending upon a required precision. Therefore, by detecting data in such a way as to avoid overquality compared to the requested precision, the operation time of the sensor device can be prevented from becoming longer. As such, the power consumption of the sensor device is reduced.

Further, it is preferable in the sensor network system according to the present invention that the transmission-cycle controlling means of the server node transmit, to the one or plural sensor device, a shortest cycle among the detection cycles thus extracted, when the transmission cycle of the one or plural sensor device needs to be changed so as to conform with request cycles at which the plural external applications transmit requests for detected-data, respectively.

Further, it is preferable in the method of controlling a sensor device of a sensor network system according to the present invention that the server node transmit, to the one or plural sensor device, a shortest cycle among the detection cycles thus extracted, when the transmission cycle of the one or plural sensor device needs to be changed so as to conform with request cycles at which the plural external applications transmit requests for detected-data, respectively.

As described above, a shortest cycle among the request cycles thus extracted is transmitted to the sensor device so that, among the requests for detected-data from plural external applications, a request transmitted at a longer cycle can be omitted. As such, it becomes possible to eliminate the power consumption on account of the receipt of a request, the detection of data, and transmission of the data by the sensor device, which is carried out each time the external applications request for detected-data.

Further, it is preferable in the sensor network system according to the present invention that the one or plural sensor device transmit, after instructed by the server node to change the detected-data transmission cycle, detected-data to the server node at the transmission cycle thus changed, without receiving a request for transmitting detected-data, the request being transmitted at a same cycle as the transmission cycle.

Further, it is preferable in the method of controlling a sensor device of a sensor network system according to the present invention that the one or plural sensor device transmit, after instructed by the server node to change the detected-data transmission cycle, detected-data to the server node at the transmission cycle thus changed, without receiving a request for transmitting detected-data, the request being transmitted at a same cycle as the transmission cycle.

With this arrangement, it becomes possible to eliminate the power consumption on account of the receipt of a request, the detection of data, and transmission of the data by the sensor device, which is carried out each time the external applications request for detected-data.

Further, it is preferable in the sensor network system according to the present invention that the one or plural sensor device: include memory means for storing one or plural detection program transmitted from the server node; and select the one or plural detection program corresponding to the request from the server node so as to detect data.

Further, it is preferable in the method of controlling a sensor device of a sensor network system according to the present invention that the sensor device: store, in memory means, one or plural detection program transmitted from the server node; and select the one or plural detection program corresponding to the request from the server node so as to detect data.

With the above arrangements, it becomes possible to eliminate the power consumption on account of the receipt of a request, the detection of data, and transmission of the data by the sensor device, which is carried out each time the external applications request for detected-data in accordance with a predetermined detection program.

Further, it is preferable in the sensor network system according to the present invention that the one or plural sensor device rewrite, in accordance with a request for rewriting the one or plural detection program, the one or plural detection program thus stored, the request being transmitted from the server node.

Further, it is preferable in the method of controlling a sensor device of a sensor network system according to the present invention that the one or plural sensor device rewrites, in accordance with a request for rewriting the one or plural detection program, the one or plural detection program thus stored, the request being transmitted from the server node.

In the above arrangements, the sensor devices rewrites, in accordance with a request for rewriting a detection program by the server node, the detection program thus stored. Therefore, then the sensor devices can detect data in accordance with the detection program thus rewritten. This makes it possible to eliminate the power consumption on account of (i) receipt, transmission, and data detection by the sensor device, which are carried out each time an external application requests for detected-data in accordance with a predetermined detection program.

Further, it is preferable that the sensor device of the present invention be included in the sensor network system described above.

Further, it is preferable that the server node of the present invention be included in the sensor network system described above.

With these arrangements, it becomes possible to provide a sensor device and a server node that allow a reduction in power consumption of the sensor devices by eliminating the power consumption on account of (i) receipt, transmission, and data detection by the sensor device, which are carried out each time an external application requests for detected-data and (ii) a power-source monitoring function in the sensor device.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A sensor network system, comprising (i) a server node that transmits and receives, via a network, a signal to/from an external device having one or plural external application and (ii) one or plural sensor device connected to the server node,
the server node comprising
sensor-device power-consumption controlling means for reducing a number of transmission from the one or plural sensor device, on the basis of request cycles at which the external application transmits a request for detected-data.

2. The sensor network system according to claim 1, wherein
the sensor-device power-consumption controlling means of the server node comprises:
detected-data request accumulating means for accumulating the request for detected-data from the external application;
transmission-cycle controlling means for (i) analyzing the request cycles so as to extract (a) detection cycles at which the one or plural sensor device needs to detect detected-data and (b) transmission cycles at which the detected-data needs to be transmitted to the server node and (ii) instructing the one or plural sensor device to (a) detect detected-data at the detection cycles thus extracted and (b) transmit the detected-data at the transmission cycles thus extracted;
storage means for storing detected-data that is transmitted from the one or plural sensor device to the server node at the transmission cycles thus extracted; and
transmitting means for transmitting the detected-data thus stored, in response to a request for detected-data from the external application.

3. The sensor network system according to claim 2, wherein
the transmission-cycle controlling means of the server node comprises:
power-source managing means for managing (i) a number of transmission to the one or plural sensor device and (ii) a number of receipt from the one or plural sensor device, so as to manage a power source of the one or plural sensor device.

4. The sensor network system according to claim 2, wherein the transmission-cycle controlling means of the server node transmits the transmission cycles thus extracted to the one or plural sensor device, when the transmission cycles of the one or plural sensor device needs to be changed so as to conform with the request cycles at which the external application requests detected-data.

5. The sensor network system according to claim 4, wherein the one or plural sensor device, after instructed by the server node to change the transmission cycles, transmits detected-data to the server node at the transmission cycles thus changed, without receiving a request for transmitting detected-data, the request being transmitted at a same cycle as the transmission cycles.

6. The sensor network system according to claim 2, wherein the transmission-cycle controlling means of the server node transmits, to the one or plural sensor device, a detected-data precision to be changed, when (i) the server node receives a request from the external application regarding a detected-data precision and (ii) the detected-data precision of the one or plural sensor device needs to be changed so as to conform with the detected-data precision that is requested.

7. The sensor network system according to claim 6, wherein the one or plural sensor device transmits, after instructed by the server node to change the detected-data precision, detected-data with the detected-data precision thus changed, without receiving again a request from the server node regarding the detected-data precision thus changed.

8. The sensor network system according to claim 2, wherein the transmission-cycle controlling means of the server node transmits, to the one or plural sensor device, a shortest cycle among the detection cycles thus extracted, when the transmission cycle of the one or plural sensor device needs to be changed so as to conform with request cycles at which the plural external applications transmit requests for detected-data, respectively.

9. The sensor network system according to claim 8, wherein the one or plural sensor device transmits, after instructed by the server node to change the detected-data transmission cycle, detected-data to the server node at the transmission cycle thus changed, without receiving a request for transmitting detected-data, the request being transmitted at a same cycle as the transmission cycle.

10. The sensor network system according to claim 2, wherein the one or plural sensor device:
comprises memory means for storing one or plural detection program transmitted from the server node; and
selects the one or plural detection program corresponding to the request from the server node so as to detect data.

11. The sensor network system according to claim 10, wherein the one or plural sensor device rewrites, in accordance with a request for rewriting the one or plural detection program, the one or plural detection program thus stored, the request being transmitted from the server node.

12. A sensor device included in a sensor network system,
the sensor network system comprising (i) a server node that transmits and receives, via a network, a signal to/from an external device having one or plural external application and (ii) one or plural sensor device connected to the server node,
the server node comprising
sensor-device power-consumption controlling means for reducing a number of transmission from the one or plural sensor device, on the basis of a request cycle at which the external application transmits a request for detected-data.

13. A server node included in a sensor network system,
the sensor network system comprising (i) a server node that transmits and receives, via a network, a signal to/from an external device having one or plural external application and (ii) one or plural sensor device connected to the server node,
the server node comprising
sensor-device power-consumption controlling means for reducing a number of transmission from the one or plural sensor device, on the basis of a request cycle at which the external application transmits a request for detected-data.

14. A method of controlling a sensor device of a sensor network system that comprises (i) a server node that transmits and receives, via a network, a signal to/from an external device having one or plural external application and (ii) one or plural sensor device connected to the server node,
the method comprising the step of reducing a number of transmission from the one or plural sensor device, on the basis of request cycles at which the external application transmits a request for detected-data.

15. The method according to claim 14, wherein the server node:
accumulates the request for detected-data from the external application;
(i) analyzes the request cycle so as to extract (a) a detection cycle at which the one or plural sensor device needs to detect detected-data and (b) a transmission cycle at which the detected-data needs to be transmitted to the server node and (ii) instructs the one or plural sensor device to (a) detect detected-data at the detection cycle thus extracted and (b) transmit the detected-data at the transmission cycle thus extracted;
stores detected-data that is transmitted from the one or plural sensor device to the server node at the cycle thus extracted; and
transmits the detected-data thus stored, in response to a request for detected-data from the external application.

16. The method according to claim 15, wherein the server node manages (i) a number of transmission to the one or plural sensor device and (ii) a number of receipt from the one or plural sensor device, so as to manage a power source of the one or plural sensor device.

17. The method according to claim 15, wherein the server node transmits the transmission cycles thus extracted to the one or plural sensor device, when the transmission cycle of the one or plural sensor device needs to be changed so as to conform with the request cycle at which the external application requests detected-data.

18. The method according to claim 17, wherein the one or plural sensor device transmits, after instructed by the server node to change the detected-data transmission cycle, detected-data to the server node at the transmission cycle thus changed, without receiving a request for transmitting detected-data, the request being transmitted at a same cycle as the transmission cycle.

19. The method according to claim 15, wherein the server node transmits, to the one or plural sensor device, a detected-data precision to be changed, when (i) the server node receives a request from the external application regarding a detected-data precision and (ii) the detected-data precision of the one or plural sensor device needs to be changed so as to conform with the detected-data precision that is requested.

20. The method according to claim 19, wherein the one or plural sensor device transmits, after instructed by the server node to change the detected-data precision, detected-data of the detected-data precision thus changed, without receiving again a request from the server node regarding the detected-data precision thus changed.

21. The method according to claim 15, wherein the server node transmits, to the one or plural sensor device, a shortest cycle among the detection cycles thus extracted, when the transmission cycle of the one or plural sensor device needs to be changed so as to conform with request cycles at which the plural external applications transmit requests for detected-data, respectively.

22. The method according to claim 21, wherein the one or plural sensor device transmits, after instructed by the server node to change the detected-data transmission cycle, detected-data to the server node at the transmission cycle thus changed, without receiving a request for transmitting detected-data, the request being transmitted at a same cycle as the transmission cycle.

23. The method according to claim 15, wherein the one or plural sensor device:
stores, in memory means, one or plural detection program transmitted from the server node; and
selects the one or plural detection program corresponding to the request from the server node so as to detect data.

24. The method according to claim 23, wherein the one or plural sensor device rewrites, in accordance with a request for rewriting the one or plural detection program, the one or plural detection program thus stored, the request being transmitted from the server node.
